(19) United States
(12) Patent Application Publication
(10) Pub. No.: US 2023/0359195 A1
(43) Pub. Date: Nov. 9, 2023

(54) METHOD FOR OPERATING A CONTROL DEVICE OF A UTILITY VEHICLE FOR CARRYING OUT A WORK PROCESS

(71) Applicant: Robert Bosch GmbH, Stuttgart (DE)

(72) Inventors: Andreas Lapp, Tamm (DE); Hendrik Kurre, Dissen (DE); Mouham Tanimou, Goeppingen (DE); Udo Schulz, Vaihingen/Enz (DE)

(21) Appl. No.: 18/246,209

(22) PCT Filed: Nov. 11, 2021
(86) PCT No.: PCT/EP2021/081338

§ 371 Date: Mar. 22, 2023

(30) Foreign Application Priority Data
Nov. 18, 2020 (DE) 10 2020 214 545.8

(51) Int. Cl. G05D 1/00

(52) U.S. Cl. CPC G05D 1/0022; G05D 1/0027; G05D 2201/0201

(57) ABSTRACT

A method for operating a control device of a utility vehicle for carrying out a work process, in particular an agricultural utility vehicle. The utility vehicle includes a large number of sub-systems, each for executing a sub-process of the work process, a control program for controlling the utility vehicle and the work process is divided into a large number of sub-programs; each sub-program is provided for controlling a relevant sub-system of the utility vehicle and for controlling a sub-process of the work process that is to be executed by this relevant sub-system; a large number of virtual machines is executed, the individual virtual machines each executing one of the sub-programs.

### FIELD

The present invention relates to a method for operating a control device of a utility vehicle for carrying out a work process, in particular an agricultural utility vehicle, preferably a combine harvester, and to a control device and a computer program for carrying out the method, and furthermore to a utility vehicle.

### BACKGROUND INFORMATION

Utility vehicles for carrying out a work process are, for example, to be understood as semi-mobile or mobile machines, which are, for example, driven by internal combustion engines or electric motors, and which may comprise tools, machines, assemblies, etc., in order to carry out a corresponding work process and, in the course thereof, to produce, machine, process, etc. particular objects or materials, for example.

Utility vehicles can find a variety of possible applications, for example in construction, for example in road construction or building construction, in the extractive industry (e.g., in mining or open-cast mining), in regular road traffic (for example as cleaning or sweeping vehicles) or, for example, also for emergency personnel, such as fire-department or fire-fighting vehicles. Agricultural utility vehicles may, for example, execute work processes for the sowing, harvesting, processing, etc. of useful plants and may, for example, be designed as a tractor or a harvesting machine, e.g., a combine harvester.

German Patent Application No. DE 10 2018 206 762 A1, for example, describes a framework for retrospectively implementing or modifying physical function features in a target device, for example in an agricultural utility vehicle, such as a combine harvester. A control device of this target device may comprise a large number of processor cores or cores, wherein an operating system may run on a master core and wherein at least one further core may be provided with virtual machines running thereon for further software applications.

Furthermore, a hypervisor may be implemented in the control device of the target device, for example a so-called light-weight hypervisor (LWHVR), which is suitable for applications in microcontroller-based control devices and for ASIL-relevant areas (automotive safety integrity level). The concept for using the LWHVR can in particular be that the operating system (OS), e.g., RTA-OS, as well as master software important for the operation, e.g., AUTOSAR, and other safety-relevant software run on the master core. Independent further software applications (also referred to as guest software) within one or more virtual machines run independently of one another with respect to runtime, memory accesses, etc. on other cores. According to the logic of the LWHVR, the master software and the virtual machines may only communicate via the so-called shared memory; accordingly, they can neither mutually invoke functions of the other nor access variables of the other.

Furthermore, a virtual machine interface is configured to provide, on the side of master software running on the master core, access to system components and system information, associated with the master core, for further software applications running on the virtual machine(s). At least one virtual machine adapter is respectively configured, as a counterpart of the virtual machine interface on each of the virtual machines, to intercept function calls of a further software application running on the respective virtual machine and to pass them to the virtual machine interface. A feature proxy-on-device is configured to provide, to the individually configured physical function features to be integrated, access to therein defined operating and target parameters of the target device. A feature coordinator-on-device is configured to coordinate each individually designed physical function feature, to be integrated or already integrated, with the remaining hardware and software resources of the target device, in particular to schedule, start, and/or stop these function features.

### SUMMARY

A method for operating a control device of a utility vehicle for carrying out a work process, a control device and a computer program for carrying out the method, and a utility vehicle are provided according to the present invention. Advantageous embodiments of the present invention are disclosed herein.

According to an example embodiment of the present invention, the utility vehicle comprises a large number of sub-systems or components for respectively executing a sub-process of the work process. For example, these sub-systems may each have different tools, machines, units, etc., and may each carry out individual parts, sections, stages, or steps of the work process. For example, in the course of the work process, particular objects may be processed, wherein these objects to be processed are passed from one sub-system to the next sub-system, and may respectively be processed in the individual sub-systems in different ways.

According to an example embodiment of the present invention, a control program for controlling the utility vehicle and thus the work process is divided or partitioned into a large number of sub-programs. Each sub-program is respectively provided for controlling a sub-system of the utility vehicle and thus for controlling a sub-process of the work process to be executed by the respective sub-system. The entire control program for controlling the entire work process is thus divided into a large number of distinct, independent, individual parts or partitions. In particular, a separate, distinct sub-program is provided for each sub-system and thus for each sub-process.

For example, the individual sub-programs can each comprise different variants or versions in order to control the respective sub-system in a different manner. For example, the respective sub-system may be adjusted depending on an object to be processed. Depending on the respective object, for example, an object-specific variant of the respective sub-program can be used to control the respective sub-system accordingly and to thus process the respective object accordingly. For example, different variants or versions of the individual sub-programs can furthermore be provided in order to control different tools of the respective sub-system.

According to an example embodiment of the present invention, on the control device, in particular in a processor unit of the control device, which expediently comprises a large number of processor cores, a large number of virtual machines is executed. The individual virtual machines each execute one of the sub-programs. Particularly expediently, a corresponding virtual machine is provided for each sub-program.

The term “virtual machine” refers to a hypothetical computer system (including hardware, operating system and software, where appropriate) that is simulated on another guest computer system formed here by the control device. A virtual machine is in particular configured as software which is executed on the control device and provides a virtual operating system as well as tasks to be executed by said virtual operating system. For example, a large number of virtual processor units may thus be simulated in the real, physical processor unit of the control device.

According to an example embodiment of the present invention, as part of the present method, a separate, individual virtual machine is provided to control each sub-system of the utility vehicle and thus to control each sub-process of the work process. The present invention thus provides a partitioning concept for the user software or control program for controlling sub-systems of complex utility vehicles. The partitioning is based on the work process and the possible associated variants and combinations of the sub-systems. Variants of the user software functions can thus be encapsulated within the individual virtual machines. The present method thus allows the user software, associated with the various possible variants and/or combinations of the sub-systems in a complex utility vehicle, for controlling the utility vehicle to be securely managed in the control device of the utility vehicle.

The respective variant of the respective user software function can, for example, be selected at the end of a belt in the production or assembly of the utility vehicle and/or during a tool change and can be downloaded into the control device, where it may then be executed, for example, by a respective associated guest system. It is furthermore possible to load several or all variants into the control device and to make a variant selection at the end of the belt or during a tool change, e.g., via configuration parameters and/or application parameters.

Advantageously, a basic functionality or basic function of the control device, in particular an operating system, e.g., RTA-OS, as well as in particular safety-relevant software, e.g., AUTOSAR, is executed by a first processor core of a processor unit of the control device. The first processor core and/or at least one second processor core of the processor unit executes the large number of virtual machines. The processor unit is thus expediently configured as a multi-core processor having a large number of processor cores. In particular, this first processor core constitutes a master core or a master processor core (“master core”) on which a corresponding master software is expediently executed. In particular, a first virtual machine that controls the basic functions of the utility vehicle may be executed in the first processor core. The further processor cores can expediently execute further virtual machines, which in turn execute the various sub-programs and thus control the individual sub-systems or sub-processes. However, it should be emphasized that the mapping of the virtual machine to the processor core is arbitrary.

A hypervisor is particularly advantageously executed on the control device, in particular on the processor unit and manages and coordinates the large number of virtual machines. This hypervisor allows in particular the operation of a plurality of virtual machines, on which the user software functions or sub-programs partitioned on the work process and the possible associated variants and combinations of the sub-systems run. Particularly expediently, the hypervisor is provided such that the master software and the virtual machines may only communicate via a shared memory so that master software and virtual machines can neither mutually invoke functions of the other nor access variables of the other. For example, for this purpose, the hypervisor may be provided as a so-called light-weight hypervisor (LWHVR), which is in particular suitable for applications in a microcontroller-based control device and furthermore for ASIL-relevant areas (automotive safety integrity level).

The present control device can expediently be configured according to the control device described in German Patent Application No. DE 10 2018 206 762 A1 and can in particular comprise corresponding software and hardware elements as described in German Patent Application No. DE 10 2018 206 762 A1. In particular, in addition to a hypervisor configured as a light-weight hypervisor (LWHVR), the present control device can in particular comprise a virtual machine interface (VMI), at least one virtual machine adapter (VMA), a feature proxy-on-device (FPoD), and a feature coordinator-on-device (FCoD) as described in German Patent Application No. DE 10 2018 206 762 A1. With regard to further details of these elements, reference is made to German Patent Application No. DE 10 2018 206 762 A1 in its entirety, the disclosure of which is also made part of the content of this application.

Preferably, a first management unit is executed by the first processor core or the master core and manages access of the individual virtual machines to resources of the control device and/or of the vehicle, in particular to software and/or hardware units, e.g., components and information. This first management unit may in particular be configured as a virtual machine interface (VMI) and may expediently provide, on the side of the master software running on the master core, access to system components and system information, associated with the master core, for the sub-programs running on the virtual machines. In particular, the first management unit or the virtual machine interface (VMI) can be configured to allow the sub-programs executed on the virtual machines to access information accessible without the VMI only to the master software, e.g., inputs/outputs of a sub-system in the control device or the utility vehicle. The first management unit or the VMI is thus in particular configured to provide or carry out controlled access of the sub-programs to a periphery of the utility vehicle via the master software.

Preferably, according to an example embodiment of the present invention, a second management unit is respectively executed for one or more of the virtual machines and respectively receives or intercepts an access request or a call or function call to the respective virtual machine and forwards or transmits it to the first management unit. Thereafter, the first management unit expediently manages the corresponding access of the corresponding virtual machine to the corresponding resource, i.e., the first management unit enables and monitors access. These second management units are in particular each configured as a virtual machine adapter (VMA), wherein such a virtual machine adapter (VMA) is respectively configured, as a counterpart of the virtual machine interface (VMI) on each of the virtual machines, to intercept function calls of a further software application running on the respective virtual machine and to pass them to the virtual machine interface. For example, the sub-program running on the respective virtual machine may be agnostic, i.e., independent of infrastructure, and may contain function calls of the master software, such as input/output access. The VMA is configured to intercept these calls and pass them to the VMI, which then forwards the corresponding requests to the master software, and vice versa. In particular, a sub-program can thereby be enabled to access operating and target parameters of the utility vehicle that are otherwise only accessible to the master software.

Preferably, according to an example embodiment of the present invention, a function switching unit is executed by the first processor core, and switches or provides access of functions, executed by the virtual machines, in particular by the sub-programs, to resources of the control device and/or of the vehicle within predetermined thresholds or predetermined parameters. The function switching unit is in particular provided as a feature proxy-on-device (FPoD) and is configured to provide the sub-programs with access to therein defined operating and target parameters of the utility vehicle. In particular, such a FPoD is configured to provide intervention points (target and operating parameters) in the utility vehicle in technically and legally permissible operating chains. The FPoD thus forms a bypass functionality in the master software, for example.

Preferably, according to an example embodiment of the present invention, a function coordination unit is respectively executed for one or more of the virtual machines and coordinates functions, executed by the virtual machines, in particular the sub-programs, and resources of the control device and/or of the vehicle. In particular, the function coordination unit plans, starts, and/or stops these functions or corresponding function features. The function coordination unit is expediently provided as a feature coordinator-on-device (FCoD) and is configured to coordinate each sub-program and its function features with the remaining hardware and software resources of the utility vehicle, in particular to schedule, start, and/or stop these function features. Such a function coordination unit can be automatically generated in the control device, for example on the basis of the interfaces used by the sub-programs in the utility vehicle as well as the dependencies between the function features.

The present method is suitable for a large number of different utility vehicles, for example for construction machines in construction, for example in road construction or building construction, or in the extractive industry, for example in mining or open-cast mining, for example for excavators, loaders, crawler-mounted vehicles, etc. Furthermore, the utility vehicle can also be used, for example, in regular road traffic, for example as cleaning or sweeping vehicles or may, for example, also be a utility vehicle for emergency personnel, e.g., a fire-department or fire-fighting vehicle.

Advantageously, the utility vehicle is an agricultural utility vehicle that executes, for example, a corresponding work process for the sowing and/or harvesting and/or processing, etc. of useful plants. For example, such an agricultural utility vehicle may be configured as a harvesting machine, tractor, etc.

Particularly advantageously, the agricultural utility vehicle is configured as a combine harvester, which executes, as a work process, harvesting of useful plants, for example grains, such as wheat, rye, oats, corn, rice, etc. or of further useful plants, e.g., sunflowers, rapeseed, etc. In the course of the work process, a large number of sub-processes are carried out in the course of which the useful plant to be harvested is respectively further processed in different ways. A corresponding sub-system is provided in the combine harvester for each of these sub-processes.

A first sub-system of the combine harvester is preferably provided for basic functions of the combine harvester and comprises, for example, an internal combustion engine and a powertrain. On the control device, a first sub-program is advantageously executed in a first virtual machine and controls the basic functions of the combine harvester. For example, the first sub-program may control regular driving or regular operation of the combine harvester, even if the latter does not execute the work process.

Preferably, a second sub-system for driving the combine harvester is provided as a corresponding sub-process of the work process. For example, this sub-system may comprise an automatic steering system using GPS (global positioning system) or GNSS (global navigation satellite system). On the control device, a second sub-program is advantageously executed in a second virtual machine and controls the sub-process of driving the combine harvester. In particular, the combine harvester is controlled such that it is moved on a field on which the useful plants to be harvested are grown, so as to effectively harvest all growing useful plants in as short a time as possible.

A third sub-system for mowing useful plants is preferably provided as a respective sub-process. For this purpose, this sub-system in particular comprises a cutting unit or expediently also a plurality of cutting units, with switching taking place between them depending on the type of plant to be harvested. On the control device, a third sub-program is advantageously executed in a third virtual machine and controls the sub-process of mowing. In the course thereof, an optimum cutting unit for the useful plant to be harvested can, for example, be selected and controlled.

Preferably, a fourth sub-system for threshing the mowed useful plants is provided as a corresponding sub-process. For this purpose, in particular, a corresponding threshing unit is provided, for example, a rotor and/or a tangential threshing unit. Advantageously, a fourth sub-program is executed on the control device in a fourth virtual machine and controls the sub-process of threshing. In particular, this sub-program is provided for controlling the threshing unit.

A fifth sub-system for separating straw and grains and/or seeds is preferably provided as a sub-process. Furthermore, the separated grains and/or seeds are expediently cleaned. In particular, for this purpose, this sub-system comprises one or more screens and in particular a fan. On the control device, a fifth sub-program is advantageously executed in a fifth virtual machine and controls the sub-process of separating. This fifth sub-program expediently controls the corresponding screens and fans of the combine harvester.

A sixth sub-system for storing the separated and, in particular, cleaned grains and/or seeds is preferably provided as a sub-process. For this purpose, a storage container or storage tank is in particular provided, and furthermore in particular a transport mechanism, for example a transfer pipe, auger, etc. On the control device, a sixth sub-program is advantageously executed in a sixth virtual machine and controls the sub-process of storing. A flow of goods can be monitored and a yield measurement can be carried out, for example.

A seventh sub-system for managing the separated straw is preferably provided as a sub-process. In particular, a chaff cutter may be provided for this purpose. Advantageously, a seventh sub-program is executed on the control device in a seventh virtual machine and controls the sub-process of managing straw. In particular, in the course thereof, placing the separated straw onto the field is controlled.

Advantageously, the first sub-program for controlling the basic functions controls the powertrain or functions of the powertrain and/or of the internal combustion engine of the combine harvester. Alternatively or additionally, the first sub-program may advantageously comprise an internal combustion engine controller. Preferably, the first sub-program, alternatively or additionally, controls auxiliary unit functions, for example, a drive of the cutting unit or generally of the auxiliary units, e.g., a load regulation of the internal combustion engine. Alternatively or additionally, the first sub-program preferably controls a longitudinal and lateral guidance. For this purpose, the first sub-program controls, for example, braking, accelerating, a so-called steer-by-wire function, etc.

Preferably, the second sub-program for controlling driving controls an automatic steering system, e.g., by means of GPS or GNSS, and/or parallel travel for transfer operations and/or a right-of-way control, e.g., on the basis of a stocking density. In particular, the second sub-program may furthermore enable manual operation or manual driving and/or automatic operation or automated or autonomous driving of the combine harvester.

Furthermore, the second sub-program may enable differences, or variants, e.g., in kinematics and steering. Furthermore, the second sub-program may, for example, control a wheel speed, a steering angle, a direction and a torque of a valve block for steering, an injection amount of the internal combustion engine, and/or a torque request for a hydraulic motor, a four-wheel request, etc.

Preferably, the third sub-program for controlling mowing controls cutting-unit types and cutting-unit functions depending on the respective useful plant variety. The combine harvester may respectively comprise individual cutting-unit types, which are functionally and mechanically different, for various useful plant varieties. For example, corn is picked, rapeseed has a lateral blade drive, etc. For example, the third sub-program may select and control different cutting units for different plant varieties, such as wheat, corn, sunflowers, rapeseed, etc. Different interfaces of the cutting units are respectively used, for example, via a so-called multi-coupler (for hydraulics, electrical supply, and control signals) between cutting unit and machine. For example, the third sub-program may control a power take-off speed, a cutting height, a cutting-unit angle of the respective cutting unit, as well as furthermore, for example, a reeling speed, a feed auger speed, a cutting-unit table adjustment, etc.

Advantageously, the fourth sub-program for controlling threshing controls a rotor threshing unit and/or a tangential threshing unit and/or an axial threshing unit and/or a hybrid threshing unit. For example, the fourth sub-program controls a rotation speed of the threshing unit, a basket distance or an actuator for the basket distance, in particular a distance between the rotor and the basket, a feed speed of an inclined conveyor, a speed request of a power take-off on the internal combustion engine, etc.

Preferably, the fifth sub-program for controlling separating controls a slope compensation, in particular a compensation of slopes by changing screen positions depending on material displacements. Furthermore, the fifth sub-program preferably controls a loss determination and/or a screen movement and/or a gap and/or a fan. For example, loss sensors at one end of the separation may be used to adjust sieving and cleaning by adjusting the oscillating screen movement and gap sizes and fans. In particular, the sub-system for separating may comprise different sieving levels and sieving concepts, which the sub-program controls accordingly. For example, the fifth sub-program may control a rotation speed of the fan or its motor, e.g., by means of a speed request or speed change of the internal combustion engine. Furthermore, the fifth sub-program may control, for example, an opening width of the screens, an oscillator frequency of the screens, an actuator for a screen distance, etc.

Preferably, the sixth sub-program for controlling storing controls a yield measurement, e.g., by means of load cells, and/or a detection of breakage and soiling, in particular, a monitoring of a flow of goods with regard to broken grain and soiling, e.g., by means of a camera, and/or a transfer. For example, a length of the transfer pipe may have kinks, which are folded in and out. Furthermore, the sixth sub-program may, for example, monitor a filling height as well as a position of the transfer pipe, an actuator or cylinder of the transfer pipe, a drive of an auger, etc.

Advantageously, the seventh sub-program for controlling the straw management controls chaffing and/or a windrow placement. For example, the seventh sub-program may, for example, control straw placement in the windrow or as a chaffed material. For example, the seventh sub-program controls a rotation speed or speed of the chaff cutter, a variable number of blades of a corresponding chaff cutter, a sensor system for adjusting the straw chaff cutter, a position of the chaff cutter and/or the windrow placement, a width control of the straw placement, an actuator for a working width and a spreading width, etc.

Alternatively or additionally, the seventh sub-program preferably controls a wind measurement and/or wind compensation. For example, a wind direction and a wind strength can be sensed by a wind sensor for this purpose, e.g., in order to detect crossing winds and to adjust the straw placement depending on the current wind.

Alternatively or additionally, the seventh sub-program preferably controls a slope measurement and/or a slope compensation. For example, in the course thereof, a slope of the combine harvester can be detected, for example by means of an inertial sensor. For example, it can thus be assessed whether the combine harvester is located on a slope and the straw should be thrown up the slope, for example.

A control device according to the present invention for a utility vehicle for carrying out a work process is configured, in particular in terms of program technology, to carry out a method according to the present invention.

A utility vehicle according to the present invention, advantageously an agricultural utility vehicle, particularly advantageously a combine harvester, comprises a control device according to the present invention, which, in particular in terms of program technology, is configured to carry out a method according to the present invention.

The implementation of a method according to the present invention in the form of a computer program or computer program product with program code for carrying out all method steps is also advantageous since this results in particularly low costs, in particular if an executing control device is also used for further tasks and is therefore present in any event. Suitable data carriers for providing the computer program are, in particular, magnetic, optical, and electric storage media, such as hard disks, flash memory, EEPROMs, DVDs, and others. A download of a program via computer networks (internet, intranet, etc.) is also possible.

Additional advantages and embodiments of the present invention result from the description and the figures.

The present invention is illustrated schematically in the figures on the basis of exemplary embodiments and is described below with reference to the figures.

### BRIEF DESCRIPTION OF THE DRAWINGS

FIG. 1 shows a schematic sectional view of a utility vehicle configured as a combine harvester with a preferred configuration of a control device according to the present invention, configured to carry out a preferred embodiment of a method according to the present invention.

FIG. 2 schematically shows a preferred configuration of a control device according to the present invention, configured to carry out a preferred embodiment of a method according to the present invention.

### DETAILED DESCRIPTION OF EXAMPLE EMBODIMENTS

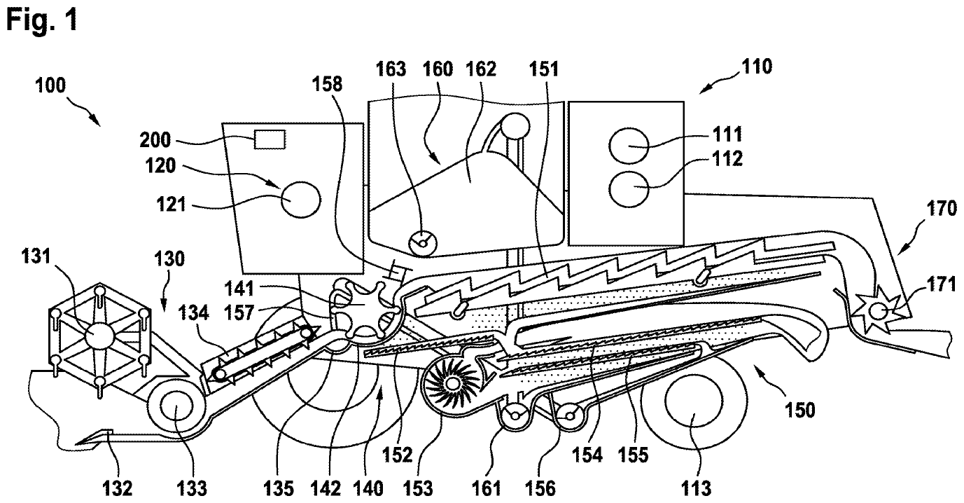

In FIG. 1, an agricultural utility vehicle configured as a combine harvester is shown in a schematic sectional view and denoted by 100.

The combine harvester 100 is configured to carry out a work process, namely to harvest useful plants, e.g., grains. For this purpose, the combine harvester 100 comprises a large number of sub-systems, each of which carries out an individual sub-process as a section or process step of the entire work process or of the entire harvesting process.

A first sub-system 110 is provided for basic functions of the combine harvester and comprises, for example, an internal combustion engine 111, a powertrain 112, a brake 113, etc.

A second sub-system 120 is provided for driving the combine harvester during harvesting, and comprises, for example, a steering system 121, which is in particular automatic.

A third sub-system 130 is provided for mowing the useful plants, e.g., the grains, in particular including collecting and feeding. For this purpose, the third sub-system 130 comprises a reel 131, a cutter bar 132, a feed auger 133, an inclined conveyor 134, and a rock catching trough 135.

A fourth sub-system 140 is provided for threshing the mowed useful plants or mowed grains and comprises, for example, a threshing drum 141 and a threshing basket 142.

A fifth sub-system 150 is provided for separating straw and grain and furthermore for cleaning the separated grain and comprises a straw walker 151, a grain pan 152, a fan 153, an upper screen 154, a lower screen 155, a return auger 156, a return 157, and furthermore a turning drum 158.

A sixth sub-system 160 is provided for storing the separated and cleaned grain and comprises a grain auger 161, a grain tank 162, and furthermore an unloading auger 163.

A seventh sub-system 170 is provided for straw management of the separated straw and comprises, for example, a straw chaff cutter 171.

It is understood that the combine harvester 100 may not necessarily comprise all of the elements discussed above and may also comprise further elements.

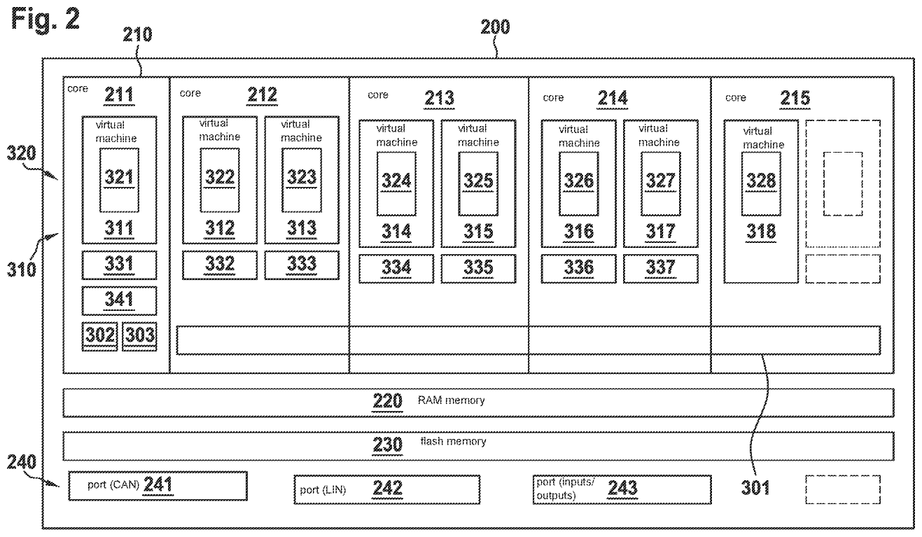

A control device 200 is provided for controlling the combine harvester 100 and the work process and is, in particular in terms of program technology, configured to execute a preferred embodiment of a method according to the present invention. A preferred configuration of the control device 200 is shown schematically in FIG. 2 and is to be explained below.

The control device 200 comprises a processor unit 210 having a large number of processor cores, for example having five processor cores 211, 212, 213, 214, 215.

Furthermore, the control device 200 comprises memory units, for example a RAM memory 220 and a flash memory 230, as well as furthermore peripheral units 240, e.g., a port 241 for a CAN fieldbus, a port 242 for a LIN bus as well as inputs and outputs 243, etc.

In the processor unit 210, a large number of virtual machines 310 are executed. For example, a first virtual machine 311 is executed by a first processor core 211. For example, two virtual machines 312, 313, 314, 315, 316, 317 are respectively executed by the further processor cores 212, 213, and 214. It should be noted that significantly more, for example up to 20, virtual machines can be executed per processor core today. The mapping of the respective virtual machine to a particular processor core takes place statically with microcontrollers, i.e., this is already defined during the development or configuration or initialization. Furthermore, a hypervisor 301, such as a light-weight hypervisor (LWHVR), for coordinating and managing the virtual machines 310 is executed by the processor unit 210.

The first processor core 211 is in particular provided as a master core on which an operating system 302 is executed, e.g., RTA-OS, as well as safety-relevant master software 303, e.g., AUTOSAR.

Furthermore, a first management unit or virtual machine interface (VMI) 331 is executed by the first processor core 211 and manages access of the individual virtual machines 310 to resources of the control device 200 and/or of the combine harvester 100.

For the virtual machines 312, 313, 314, 315, 316, 317, a second management unit or virtual machine adapter (VMA) 332, 333, 334, 335, 336, 337 is respectively executed and respectively receives an access request of the respective virtual machine 312-317 and forwards it to the first management unit or VMI 331.

A function switching unit or feature proxy-on-device (FPoD) 341 is furthermore executed by the first processor core 211 and switches access of functions, executed by the virtual machines 310, to resources of the control device 200 and/or of the combine harvester 100 within predetermined thresholds.

A first virtual machine 318 is executed by a further processor core 215. A function coordination unit or feature coordinator-on-device (FCoD) 328 is executed in the virtual machine 318 and coordinates functions or control programs, executed by the virtual machines 310, and resources of the control device 200 and/or of the combine harvester 100.

The virtual machine 318 in which a function coordination unit or a feature coordinator-on-device (FCoD) 328 is executed could also be operated by one of the other processor cores 212-214, which also operate the virtual machine adapters (VMAs) with the associated virtual machines and the associated functions or control programs or sub-programs.

The mapping of the virtual machine 318 to a processor core 212-215 takes place statically with microcontrollers, i.e., this is already defined during the development or configuration or initialization.

A control program 320 for controlling the combine harvester 100 and for controlling the work process is executed in the processor unit 210. The control program 320 is divided into a large number of independent sub-programs 321, 322, 323, 324, 325, 326, 327.

Each of these sub-programs 321, 322, 323, 324, 325, 326, 327 is respectively provided to control one of the sub-systems 110, 120, 130, 140, 150, 160, 170 of the combine harvester 100 and to control a sub-process of the work process to be executed by the respective sub-system. In each of the virtual machines 311, 312, 313, 314, 315, 316, 317, one of the sub-programs 321, 322, 323, 324, 325, 326, 327 is respectively executed.

In a first virtual machine 311, a first sub-program 321 is executed and controls the sub-system 110 for the basic functions of the combine harvester 100. For example, the first sub-program 321 controls the internal combustion engine 111, the powertrain 112, and the brake 113.

In a second virtual machine 312, a first sub-program 322 is executed and controls the sub-system 120 or the sub-process of driving the combine harvester 100. For example, the second sub-program 322 controls the automatic steering system 121.

In a third virtual machine 313, a third sub-program 323 is executed and controls the sub-system 130 or the sub-process of mowing. For example, the third sub-program 323 controls the reel 131, the cutter bar 132, the feed auger 133, the inclined conveyor 134.

In a fourth virtual machine 314, a fourth sub-program 324 is executed and controls the sub-system 140 or the sub-process of threshing. For example, the fourth sub-program 324 controls the threshing drum 141 of the threshing unit.

In a fifth virtual machine 315, a fifth sub-program 325 is executed and controls the sub-system 150 or the sub-process of separating. For this purpose, the fifth sub-program 325 controls the straw walker 151, the fan 153, the upper screen 154, the lower screen 155, and the return auger 156, for example.

In a sixth virtual machine 316, a sixth sub-program 326 is executed and controls the sub-system 160 or the sub-process of storing. For example, the sixth sub-program 326 controls the grain auger 161 and the unloading auger 163.

In a seventh virtual machine 317, a seventh sub-program 327 is executed and controls the sub-system 170 or the sub-process of straw management. For example, the seventh sub-program 327 controls the straw chaff cutter 171.

The feature proxy-on-device 341 can furthermore be configured to monitor central or critical operating relationships of the function features or user software function of the sub-programs 320, which, e.g., relate to the functional crop-dependent and/or work-process-related sequence of functions. A functional integrity of an overall system of the combine harvester 100 can thereby be ensured. Such monitoring can also take place at the runtime of the function feature or the user software function or the sub-programs 320.

Operating relationships that are also mapped in the function software 320 and in the configuration of the hypervisor 301 result, for example, from components of the combine harvester 100 that are mechanically connected to a belt drive. For example, a main drive unit, e.g., a diesel engine, as well as furthermore all mechanically driven units, e.g., the threshing unit, a hydrostatic traction drive, etc. can be connected in this case.

Furthermore, operating relationships of the sub-processes of the work process result. For example, a higher forward speed means more harvested crops. This results in an increase in the inclined conveyor speed, which in turn results in an increase in the threshing unit speed and in an increase in the distance to the basket due to the increased number of materials.

Accordingly, the speed of the fan is increased. A screen distance may initially be kept constant, but a conveying speed of the auger into the storage unit is increased due to the increased number of grains. Accordingly, a rotation speed of the blades of the straw chaff cutter is also increased.

The feature coordinator-on-device 328 may be automatically generated in the control device 200, in particular on the basis of the interfaces, used by the function features of the sub-programs 322-327, in the combine harvester 100 and the dependencies between the function features. In particular, FCoD 328 may implement ensuring, checking, and/or monitoring the fulfillment of predetermined technical requirements. In particular, it may thereby be considered that particular function features may be based on other function features. For example, a distance control may require a cruise control.

For example, functional dependencies may be considered for the control program 320 or for the sub-programs 321-327. For example, for an automatic parallel travel during a transfer from the combine harvester 200 to a transfer trailer, an automatic steering system may be used in both machines, i.e., in the combine harvester 200 and the transfer trailer. For example, a GNSS is used for automatic steering of the combine harvester 200. For example, in order to automatically optimize the threshing unit with a multi-target optimization (e.g., with respect to breakage, speed, losses), a break detection, a speedometer, a loss sensor, and associated software functions are used.

Furthermore, in particular for the control device 200, a suitable order as well as parallelization of function features can be considered in the generation of the FCoD 328. The order and/or parallelization of function features may, for example, be implemented statically within operating chains or may be activated or deactivated at the runtime of the function features.

For example, parallel or independent or sequential or dependent functions may be considered for the control program 320 or for the sub-programs 321-327. A steering system is, for example, independent of the (harvested-crop) processing process. An analysis of the environment (losses, breakage) is, for example, independent of how the useful plants are cut. In contrast, a parallelism of the control processes is, for example, dependent on a travel time or latency of harvested crops through the machine. Grid losses in control function calls may be permitted, for example, to a limited extent.

The present method may, for example also be used for use in an autonomous utility vehicle. For this purpose, further virtual machines that enable autonomous operation of the utility vehicle may, for example, be provided. For example, a virtual machine with a corresponding sub-program for autonomous route guidance may be provided as an extension to a steering system. Trajectory planning and obstruction detection may be realized therein, for example. For example, a separate virtual machine may also be provided for remote access to the utility vehicle in the event of an error.

1-15. (canceled)

16. A method for operating a control device of a utility vehicle for carrying out a work process, the utility vehicle including a large number of sub-systems, each of the sub-systems configured to execute a respective sub-process of the work process, wherein a control program for controlling the utility vehicle and the work process is divided into a large number of sub-programs, wherein each sub-program of the sub-programs is configured to control a respective sub-system of the sub-systems of the utility vehicle and to control the respective sub-process of the work process executed by the respective sub-system, the method comprising:
executing a large number of virtual machines, each individual virtual machine of the virtual machines respectively executing one of the sub-programs.

17. The method according to claim 16, wherein the utility vehicle is an agricultural utility vehicle.

18. The method according to claim 16, wherein a first processor core of a processor unit of the control device executes a basic functionality of the control device including an operating system and safety-relevant software, and wherein the first processor core and/or at least a second processor core of the processor unit executes the large number of virtual machines.

19. The method according to claim 18, wherein: (i) the first processor core executes a first management unit, which manages access of the individual virtual machines to resources of the control device and/or of the utility vehicle, and/or (ii) for each of one or more respective virtual machines of the virtual machines, a second management unit is respectively executed and respectively receives an access request of the respective virtual machine and forwards it to the first management unit, and/or (iii) wherein the first processor core executes a function switching unit which manages access of functions, executed by the individual virtual machines, to resources of the control device and/or of the utility vehicle within predetermined thresholds, and/or (iv) a function coordination unit is executed for one or more of the virtual machines and coordinates functions, executed by the one or more virtual machines, and resources of the control device and/or of the utility vehicle.

20. The method according to claim 16, wherein the utility vehicle is configured as a combine harvester, wherein a first sub-system of the combine harvester is provided for basic functions of the combine harvester, wherein on the control device, a first sub-program is executed in a first virtual machine and controls the basic functions of the combine harvester, wherein a second sub-system of the combine harvester is provided for driving the combine harvester, wherein on the control device, a second sub-program is executed in a second virtual machine and controls a sub-process of driving the combine harvester, wherein a third sub-system of the combine harvester is provided for mowing useful plants, wherein on the control device, a third sub-program is executed in a third virtual machine and controls a sub-process of mowing, wherein a fourth sub-system of the combine harvester is provided for threshing the mowed useful plants, wherein on the control device, a fourth sub-program is executed in a fourth virtual machine and controls a sub-process of threshing, wherein a fifth sub-system of the combine harvester is provided for separating straw and grains and/or seeds, wherein on the control device, a fifth sub-program is executed in a fifth virtual machine and controls a sub-process of separating, wherein a sixth sub-system of the combine harvester is provided for storing the separated grains and/or seeds, wherein on the control device, a sixth sub-program is executed in a sixth virtual machine and controls a subprocess of storing, wherein a seventh sub-system of the combine harvester is provided for straw management of the separated straw, wherein on the control device, a seventh sub-program is executed in a seventh virtual machine and controls a sub-process of straw management.

21. The method according to claim 20, wherein the first sub-program for controlling the basic functions controls one or more of the following functions:
a powertrain function; and/or
an internal combustion engine control; and/or
auxiliary unit functions; and/or
a longitudinal and lateral guidance.

22. The method according to claim 20, wherein the second sub-program for controlling driving controls one or more of the following functions:
an automatic steering system; and/or
parallel driving for transfer operations; and/or
a right-of-way control.

23. The method according to claim 20, wherein the third sub-program for controlling mowing controls cutting-unit types and cutting-unit functions depending on a respective useful plant variety.

24. The method according to claim 20, wherein the fourth sub-program for controlling threshing controls one or more of the following functions:
a rotor threshing unit; and/or
a tangential threshing unit; and/or
an axial threshing unit; and/or
a hybrid threshing unit.

25. The method according to claim 20, wherein the fifth sub-program for controlling separating controls one or more of the following functions:
a slope compensation; and/or
a loss determination; and/or
a screen movement; and/or
a gap; and/or
a fan.

26. The method according to claim 20, wherein the sixth sub-program for controlling storing controls one or more of the following functions:
a yield measurement; and/or
a detection of breakage and soiling; and/or
a transfer.

27. The method according to claim 20, wherein the seventh sub-program for controlling the straw management controls one or more of the following functions:
a chaff cutter; and/or
a windrow placement; and/or
a wind measurement; and/or
a wind compensation; and/or
a slope measurement; and/or
a slope compensation.

28. A control device for a utility vehicle for carrying out a work process, the utility vehicle including a large number of sub-systems, each of the sub-systems configured to execute a respective sub-process of the work process, wherein a control program for controlling the utility vehicle and the work process is divided into a large number of sub-programs, wherein each sub-program of the sub-programs is configured to control a respective sub-system of the sub-systems of the utility vehicle and to control the respective sub-process of the work process executed by the respective sub-system, the control device configured to:
execute a large number of virtual machines, each individual virtual machine of the virtual machines respectively executing one of the sub-programs.

29. An agricultural utility vehicle configured to carry out a work process, the utility vehicle comprising:
a control device, the utility vehicle including a large number of sub-systems, each of the sub-systems configured to execute a respective sub-process of the work process, wherein a control program for controlling the utility vehicle and the work process is divided into a large number of sub-programs, wherein each sub-program of the sub-programs is configured to control a respective sub-system of the sub-systems of the utility vehicle and to control the respective sub-process of the work process executed by the respective sub-system, the control device configured to:
execute a large number of virtual machines, each individual virtual machine of the virtual machines respectively executing one of the sub-programs.

30. A non-transitory machine-readable storage medium on which is stored a computer program for operating a control device of a utility vehicle for carrying out a work process, the utility vehicle including a large number of sub-systems, each of the sub-systems configured to execute a respective sub-process of the work process, wherein a control program for controlling the utility vehicle and the work process is divided into a large number of sub-programs, wherein each sub-program of the sub-programs is configured to control a respective sub-system of the sub-systems of the utility vehicle and to control the respective sub-process of the work process executed by the respective sub-system, the computer program, when executed by a control device, causing the control device to perform:
executing a large number of virtual machines, each individual virtual machine of the virtual machines respectively executing one of the sub-programs.
